(19) United States
(12) Patent Application Publication
(10) Pub. No.: US 2006/0112126 A1
(43) Pub. Date: May 25, 2006

(54) Automatic screen pop showing troubleshooting information

(76) Inventors: Carlos Soto, Morgan Hill, CA (US); Joe Dickens, Santa Clara, CA (US); Louisa Mak, Mountain View, CA (US); Stan Tomberg, San Jose, CA (US); Subhash Tantry, Palo Alto, CA (US)

Correspondence Address: KAPLAN GILMAN GIBSON & DERNIER L.L.P., 900 ROUTE 9 NORTH, WOODBRIDGE, NJ, 07095, US

(21) Appl. No.: 10/990,017

(22) Filed: Nov. 16, 2004

(51) Int. Cl. G06F 7/00

(52) U.S. Cl. 707/102

(57) ABSTRACT

A method for efficiently and conveniently providing a remote troubleshooting service, in which a screen window automatically pops up, in response to an incoming call reporting a problem encountered at a client computer, to show the information that is helpful in solving the problem. The calling number or network address associated with the client computer is used as a key to query a database to obtain the helpful information, which is preferably updated periodically by running a software application in the client computer.

### TECHNICAL FIELD

The present invention relates to troubleshooting techniques, and more particularly, to a method and system for a trouble reporting center to remotely process a problem or trouble encountered at a client computer in a more efficient and convenient manner as compared to the prior art.

### BACKGROUND OF THE INVENTION

When a client computer, such as a workstation in a network, encounters a problem, the client often calls a trouble reporting center, such as a helpdesk of the network service provider, for help. Upon receiving the call from the client, a help representative or agent at the trouble reporting center may walk the client user through the troubleshooting steps by conversation over the telephone call or by text chat. The agent may also remotely troubleshoot the problem by himself through remote control techniques. For solving the problem, the agent needs to know some information about the problematic client computer that is helpful to diagnose and troubleshoot the client computer, such as the settings or configuration information of the client computer, and preferably the history as well. However, it is very inconvenient, inaccurate and both time and labor consuming for the agent to collect the information from the client.

Therefore, there exists a need for a more efficient and convenient solution in the remote troubleshooting process.

### SUMMARY OF THE INVENTION

The present invention provides a method for a trouble reporting center to process a trouble report. Specifically, as taught by the present invention, in response to receiving an incoming call reporting a trouble or problem encountered at a client computer, a window automatically pops up on a computer screen of the center showing information that is helpful in solving the trouble. Thus, the service agent can figure out the problem quickly and efficiently with the help of the information shown on the pop window.

Preferably, the information is obtained from a database kept by the trouble reporting center. An identifier of the client computer is used as a key to query the database, which may be a calling number, a network address or an account number associated with the client computer.

As an addition or an alternative, some of the information may be collected from the client computer by running a software application on the client computer. Preferably, the software application periodically collects the information to update the records in the database.

Preferably, the information comprises accounting information, configuration information and historic information associated with the client computer, which is helpful in solving the problem.

### BRIEF DESCRIPTION OF THE DRAWINGS

The above and other features and advantages of the present invention can be better understood with reference to the accompanying drawings in which:

FIG. 1 schematically illustrates an exemplary trouble processing system according to the present invention;

FIG. 2 shows an exemplary embodiment of the pop window according to the present invention; and

FIG. 3 illustrates the process of the method according to a preferred embodiment of the present invention.

### DETAILED DESCRIPTION OF THE PREFERRED EMBODIMENTS

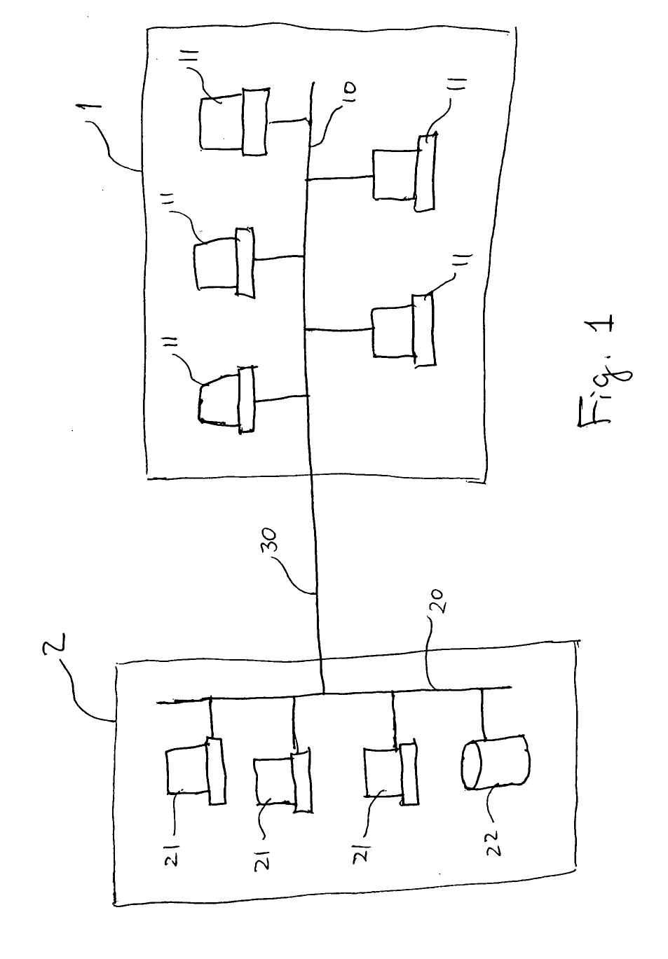

An exemplary embodiment of the remote troubleshooting system implementing the teachings of the present invention is illustrated in FIG. 1. In this embodiment, the trouble reporting center 2 is a network service provider that provides IT management services to a client network 1 which comprises plural client computers or workstations 11 connected to each other over a local area network (LAN) 10. Typically the network service provider 2 comprises plural agent computers 21 for the representatives or agents to service the clients. The agent computers 21 are connected to each other over a local area network (LAN) 20 to share resources and information within the service provider 2. The service provider 2 and the client network 1 are typically remotely located from each other, and are connected via a data communications link 30 (such as Internet) through proper firewalls (not shown).

According to the teaching of the present invention, the service provider 2 further comprises a database 22 for storing information that is helpful in troubleshooting client computers 11. The agent computers 21 can get access to the database 22 through the LAN 20. Preferably, each of the service client computers 11 has a corresponding account in the database 22 to store the information associated with each specific client computer 11.

The information stored in each account in the database 22 may be any information that is helpful for diagnosing and troubleshooting the specific client computer 11 associated with the account. Such information may comprise account information of the client computer, such as the user name, password, telephone number, email address of the account, etc. The information preferably comprises configuration information of the client computer (such as hardware configuration of the boards, memory amount, RAM, etc.) and the settings of the network 1 (such as information about the domain controllers, IP addresses of the client computers 11, active directory, other related computers in the network neighborhood, etc.).

Preferably, the information in each account may comprise historic information about the client computer 11. For example, the information may include the history of the computer assets, the history of the activities, the history of maintenance and the history of diagnosing and troubleshooting, of the client computer 11.

According to the teaching of the present invention, when the service provider 2 receives and answers an incoming call from a client reporting that trouble is encountered at a client computer 11, a window automatically pops up and shows the helpful information on a computer screen in front of the agent that answers the call. As explained above, the helpful information may include various information that is helpful to diagnose and troubleshoot the problematic client computer 11, such as account information, configuration information, history information, etc.

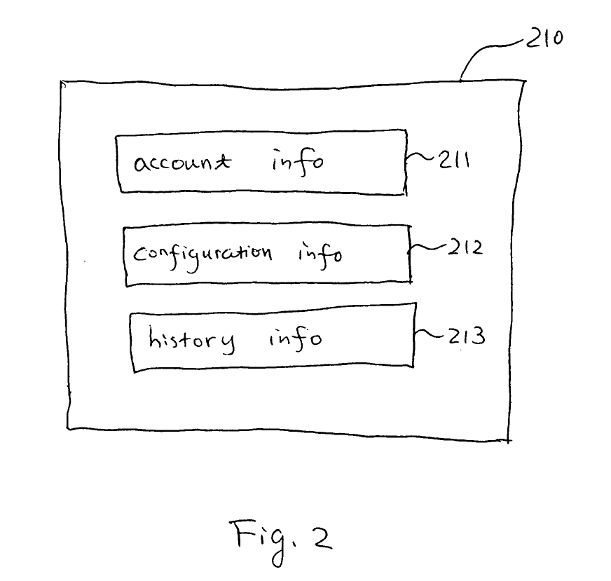

The pop window may show the information in any desired format. Preferably, not all the information associated with the client computer 11 is shown in a single window, but rather is selectively shown in various depths and scrollable by the agent from screen to screen. For example, as shown in FIG. 2, the pop up window 210 may include several selection buttons 211, 212, 213 for the agent to select a proper category of information that he believes useful.

Preferably, the information is obtained automatically from the database 22 with an identifier of the problematic client computer 11 as a key to the database 22.

Such an identifier of each client computer 11 may be a calling number of the incoming call, which is registered with the service provider 2 to be associated with the specific client computer 11, for example, during a registration process. Conveniently, a land telephone beside a client computer 11 may be registered to be associated with this specific client computer 11. The user may also register more than one telephone number with one client computer 11. For example, in addition to the land telephone, the user may also register his mobile phone number to be associated with the same client computer 11. Upon receiving an incoming call, the service provider may automatically use the calling telephone number as a key to obtain, from the database 2, the helpful information in the account associated the problematic client computer 11.

Alternatively, the identifier may be an account number or a user ID associated with the problematic client computer 11. Preferably, the account number or the user ID is requested to be input on the dial pad when the user calls the service provider 2.

Alternatively, the identifier can be a network address (such as an IP address) of the client computer 11. This is advantageous if the client calls the service provider 2 from the problematic client computer 11 using an instant data communications service such as Internet telephony, instant messaging or text chat which inherently provides the network address of the client computer 11 from which the trouble reporting session is initiated.

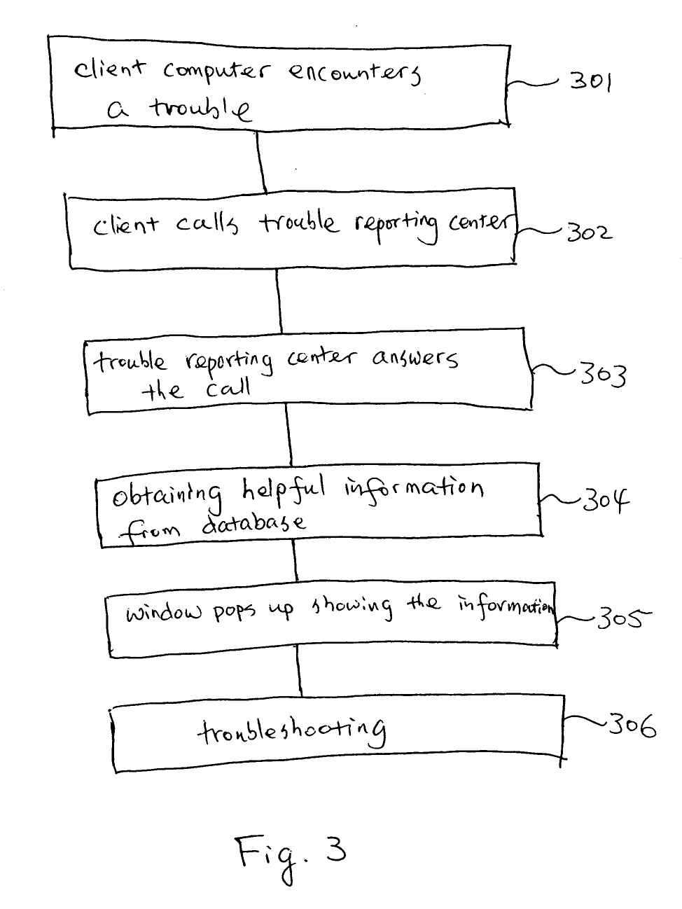

FIG. 3 illustrates an exemplary process of the troubleshooting method according to the present invention. At step 301, a client computer 11 encounters a trouble or problem. The client needs help, so he calls the service provider at step 302. An agent of the service provider 2 answers the call at step 303. Using the identifier that identifies the problematic client computer 11 as a key, which is provided in the incoming call, the system automatically obtains, from the database 22, helpful information in the account associated with the identified client computer 11, at step 304. At step 305, a window automatically pops up at the agent computer 21, showing the helpful information to the agent. Then the agent diagnoses and troubleshoots the problematic client computer 11 with the help of the information shown on the pop window, at step 306. Thus, with the helpful information automatically popping up in front of the agent upon receiving the trouble reporting call, the agent does not need to communicate with the client to obtain the helpful information, nor does he need to search the database for the information he needs.

In a preferred embodiment, the information stored in the database is periodically updated. For example, a software application may run periodically on each client computer 11 to collect at least some of the information and automatically send the collected information to the service provider 2 to update the database 2.

In a preferred embodiment, in addition to obtaining the information from the database, at least some of the information can be collected from the problematic client computer 11 in a real time mode. More specifically, when receiving an incoming call, the agent may require the calling user to run a software application on the problematic client computer 11 to collect some information for helping the troubleshooting. For example, the software application may run to collect the history of recent activities of the client computer 11 and automatically transmits the history to the agent, which is shown on the pop window. In an embodiment, the agent may transmit the software application to the problematic client computer 11 upon receiving the incoming call for help.

The above describes the preferred embodiments of the present invention. However, it will be appreciated that, without departing the spirit of the present invention, numerous adaptations, variations and modifications are readily available to a person with ordinary skill in the art. For example, the pop window may further show locations of other information that could be important for solving the trouble. Thus, the scope of the present invention is intended to be solely defined in the accompanying claims.

What is claimed is:

1. A method for a trouble reporting center to process a trouble report, comprising the steps of:
receiving, at the trouble reporting center, an incoming call reporting a trouble encountered at a client computer; and
in response to said receiving, automatically popping up a window on a computer screen at said trouble reporting center, said windows showing information indicative of a configuration of said client computer that is helpful in solving said trouble.

2. The method of claim 1, further comprising automatically obtaining said information from a database kept at said trouble reporting center.

3. The method of claim 2, wherein an identifier of said client computer is used as a key to query said database to obtain said information.

4. The method of claim 3, wherein said identifier is a calling number of said incoming call.

5. The method of claim 3, wherein said identifier is a network address of said client computer.

6. The method of claim 5, wherein said incoming call is made from said client computer over a data network.

7. The method of claim 3, wherein said identifier is an account number associated with said client computer.

8. The method of claim 1, further comprising running a software application on said client computer to collect at least some of said information from said client computer and transmitting said collected information to said trouble reporting center.

9. The method of claim 2, further comprising periodically running a software application on said client computer to collecting at least some of said information at said client computer and automatically transmitting said collected information said database so as to update said information.

10. The method of claim 1, wherein said information comprises configuration information of said client computer.

11. The method of claim 10, wherein said configuration information comprises at least one of configuration of boards, memory amount, and RAM of said client computer.

12. The method of claim 10, wherein said configuration information comprises information about at least one of following: domain controllers, IP addresses, network settings, active directory and other related computers.

13. The method of claim 1, wherein said information comprises account information associated with said client computer.

14. The method of claim 1, wherein said information comprises a history of computer assets and/or activities of said client computer.

15. The method of claim 15, wherein said information further comprises a troubleshooting and/or maintenance history of said client computer.

16. A trouble processing center for providing troubleshooting services to client computers, comprising:
a database for storing information helpful for said troubleshooting, said information being associated with each of said client computers;
means for receiving incoming calls from said client computers;
means for obtaining, from said database, said information associated with one of said client computers upon receiving an incoming call for troubleshooting said one client computer; and
means for automatically popping up a window in an agent computer showing said obtained information.

17. The trouble processing center of claim 16, wherein a key to query said database for obtaining said information associated with said one client computer is an identifier of said one client computer.

18. The trouble processing center of claim 17, wherein said key is a calling number, an network address or an account number associated with said one client computer.

19. The trouble processing center of claim 16, wherein said information comprises configuration information of each of said client computers.

20. The trouble processing center of claim 19, wherein said configuration information comprises at least one of the following: configuration of boards, memory amount, RAM, domain controllers, IP addresses, network settings, active directory and other related computers.

21. The trouble processing center of claim 16, wherein said information comprises account information associated with each of said client computers.

22. The trouble processing center of claim 16, wherein said information comprises a history of computer assets, activities, troubleshooting and/or maintenance of each of said client computers.

23. A method for solving a problem encountered by a client computer, comprising:
receiving, at a service provider, a call from said client computer reporting said problem, said call including an identifier identifies said client computer;
using, at said service provider, said identifier as a key to query a database for obtaining information associated with said identified client computer and helpful in solving the problem;
automatically popping up a window showing said obtained information on a computer screen at said service provider.

24. The method of claim 23, further comprising periodically updating said information in said database.

25. The method of claim 24, further comprising periodically running a software application on said client computer to collect said information and automatically sendng said collected information to said database for said updating.

26. The method of claim 23, wherein said information comprises configuration information, computer assets history, activity history, account information, troubleshooting history and/or maintenance history associated with said client computer.

27. The method of claim 23, wherein said service provider is remotely located from said client computer and is connected with said client computer over a data network.
